(19) United States
(12) Patent Application Publication
(10) Pub. No.: US 2011/0310205 A1
(43) Pub. Date: Dec. 22, 2011

(54) PRINTING MACHINE AND METHOD FOR PRINTING A SUBSTRATE

(75) Inventors: Frank Kleine Jäger, Bad Durkheim (DE); Jürgen Kaczun, Wachenheim (DE); Udo Lehmann, Bickenbach (DE)

(73) Assignee: BASF SE, LUDWIGSHAFEN (DE)

(21) Appl. No.: 13/140,530

(22) PCT Filed: Dec. 14, 2009
(86) PCT No.: PCT/EP09/67022

§ 371 Date: Jun. 17, 2011

(30) Foreign Application Priority Data
Dec. 17, 2008 (EP) 08171921.3

(51) Int. Cl. B41J 2/01

(52) U.S. Cl. 347/103

(57) ABSTRACT

The invention relates to a method for printing a substrate (7), in which ink is transferred from an ink carrier (3) to the substrate (7) in accordance with a predefined pattern by energy being introduced into the ink through the ink carrier (3) by a device for the introduction of energy (11), the ink carrier (3) and the substrate (7) not coming into contact. The substrate (7) is introduced into an electric field, so that a homogeneous charge field is produced on the surface of the substrate (7). The invention further relates to a printing machine, comprising an ink carrier (3) which can be coated with an ink to be printed, and a device (11) for the introduction of energy into the ink, the device (11) for the introduction of energy being arranged in such a way that the energy can be introduced into a printing area (9) on the side of the ink carrier (3) facing away from the ink, so that the ink is transferred from the ink carrier (3) to a substrate (7) to be printed in an area of action of the energy. Furthermore, in order to produce an electric field, a voltage source (19; 21) or a current source (19; 21) is comprised, in order to produce a homogeneous charge field on the surface of the substrate (7).

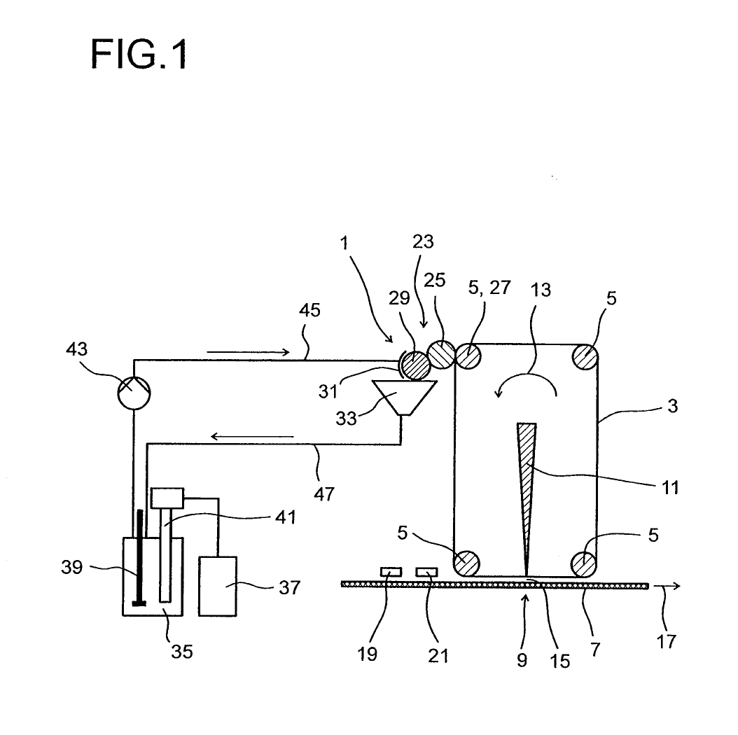

The invention relates to a method for printing a substrate, in which ink is transferred from an ink carrier to the substrate in accordance with a predefined pattern, by energy being introduced into the ink through the ink carrier by a device for the introduction of energy, the ink carrier and the substrate not coming into contact. Furthermore, the invention relates to a printing machine, comprising an ink carrier which can be coated with an ink to be printed, and a device for the introduction of energy into the ink, the device for the introduction of energy being arranged in such a way that the energy can be introduced in a printing area on the side of the ink carrier facing away from the ink, so that ink is transferred from the ink carrier to a substrate to be printed in an area of action of the energy.

A method for printing a substrate in which ink drops are thrown onto a substrate to be printed from a carrier coated with an ink is known, for example from U.S. Pat. No. 6,241,344. In order to transfer the ink, at the position at which the substrate is to be printed, energy is introduced through the carrier into the ink on the carrier. As a result, some of the ink evaporates, so that it is separated from the carrier. As a result of the pressure of the evaporating ink, the drop of ink separated in this way is thrown onto the substrate. By means of directed penetration of the energy, in this way the ink can be transferred to the substrate in accordance with a pattern to be printed. The energy needed to transfer the ink is introduced, for example, by a laser. The carrier to which the ink is applied is, for example, a circulating belt, to which ink is applied with the aid of an application device before the printing area. The laser is located in the interior of the circulating belt, so that the laser acts on the carrier on the side facing away from the ink.

A corresponding printing machine is further known, for example also from U.S. Pat. No. 5,021,808. Here, too, ink from a storage container is applied to a circulating belt by an application device, there being a laser within the circulating belt, by means of which the ink is evaporated at predefined positions and in this way is thrown onto the substrate to be printed. In this case, the belt is fabricated from a material that is transparent to the laser. In order to evaporate the ink in a specific manner, it is possible for the circulating belt to be coated with an absorption layer, in which the laser light is absorbed and converted into heat and thus evaporates the ink at the position at which the laser is used.

The application of the ink to the flexible carrier is in this case generally carried out by roll-based units, a roll dipping into a storage container containing ink, and the ink being transferred to the flexible carrier with the aid of the roll.

The disadvantage of the known printing devices is that the printing quality depends to a great extent on the homogeneity of the conditions involved in the process. For example, even extremely small local differences directly at the point of input of the energy can lead to a qualitative impairment of the printed result. Such differences are, for example, differences in the thickness of the ink application and, for example, also the electrostatic state of the substrate to be printed. For instance, as a result of diverse unwinding operations, a conventional polymer or else paper surface has a completely disordered static surface charge, which is also very inhomogeneous in terms of its voltage potential. The printed image resulting from this has a strong tendency to inexact edges and borders, which are primarily caused by undefined spraying and atomization of the ink.

It is an object of the present invention to provide a method and a printing machine for printing a substrate, in which inexact edges and borders in the printed image are reduced or avoided.

The object is achieved by a method for printing a substrate, in which ink is transferred from an ink carrier to the substrate in accordance with a predefined pattern by energy being introduced into the ink through the ink carrier by a device for the introduction of energy, the ink carrier and the substrate not coming into contact. The substrate is introduced into an electric field, so that a charge field is produced on the surface of the substrate.

The charge field can be both homogeneous and heterogeneous. A heterogeneous charge field can have a gradient, for example, or can be formed in accordance with the pattern to be printed. However, the charge field is preferably homogeneous.

As a result of the homogeneous charge field on the surface of the substrate, an improvement in the printed image is achieved. For example, in particular more exact edges and borders can be produced than on a substrate on which no homogeneous charge field is impressed on the surface. In this case, the improvement in the printed image is achieved despite the printing gap at which the ink is transferred from carrier to the substrate, which initially leads to disordered field lines. Here, the printing gap is the gap between ink carrier and substrate, in which the ink is transferred from the ink carrier to the substrate.

Furthermore, it is likewise unnecessary to build up a defined opposing pole. It is sufficient to impress a largely homogeneous charge image on the substrate to be printed. Even a low but homogeneous potential distribution on the surface of the substrate to be printed already leads to a reduction in the atomization of the ink to be printed, and therefore to more exact edges and borders in the printed image. A further advantage of introducing the substrate into the electric field in order to produce a homogeneous charge field on the surface of the substrate is that, if the potential is raised, the quantity of ink that is transferred is increased.

In order that a homogeneous charge field is built up on the surface of the substrate in the transfer region of the ink, it is advantageous if the substrate is introduced into the electric field before the transfer of the ink. In order to produce the electric field, for example a voltage can be applied or a current can be imposed. The application of the voltage can in this case be carried out with or without contact. The voltage is normally applied by applying an electrode to the substrate. In this case, the electrode used can cover only a part or the entire width of the substrate to be printed. It is preferred if the electrode covers the entire width of the substrate. To this end, it is possible for example to use a rod electrode, along which the substrate is guided. This can be done both with and without contact. Preferably, the electrode does not come into contact with the substrate.

In a first embodiment, the substrate to be printed is substantially discharged homogeneously in order to produce the homogeneous charge field on the surface by means of the application of the voltage or the transfer of the current. If the substrate is discharged by applying a current, it is possible to dissipate the charge directly or indirectly. Suitable circuits with which the charge may be dissipated are known to those skilled in the art.

If the substrate is to be discharged by applying a voltage, a discharge potential or a ground potential is applied to the substrate. In this way, the potential on the surface of the substrate is reduced. In order to be able to discharge the substrate, the discharge potential is lower than the potential of the substrate is to be discharged. Suitable methods for discharging the substrate by applying a voltage are likewise known to those skilled in the art.

In an alternative embodiment, the substrate is substantially charged up homogeneously by the application of the voltage or the transfer of the current. The application of the voltage or the transfer of the current can in this case be carried out in any desired way known to those skilled in the art. To this end, a voltage source or a current source is normally connected to the substrate.

In a further, preferred embodiment, the substrate is firstly discharged and then charged up in order to apply a homogeneous charge field to the surface. In this case, the discharging and charging can be carried out as described previously. It is firstly possible for the discharging to be carried out by applying a voltage and the charging by transferring a current or for the discharging by transferring a current and the charging by applying a voltage. Furthermore, it is also possible for both the discharging and the charging to be carried out by applying a voltage or transferring a current.

Even given a low but homogeneous potential distribution on the surface, a great reduction in the atomization of the ink to be applied is exhibited. In this way, the precision of edges and borders in the printed image is increased. Raising the homogeneous potential, for example by applying a higher voltage or transferring a higher current, can additionally transfer a higher quantity of ink. In this way, improved coverage with ink can be achieved and, as a result, likewise an improved printed image.

To achieve a homogeneous printed image, it is also advantageous if the substrate to be printed and the ink carrier have in the printing area a printing gap in the range from 0 to 2 mm, in particular in the range from 0.01 to 1 mm. The smaller the printing gap between the ink carrier and the substrate to be printed, the less the droplet widens when it strikes the substrate to be printed and the more uniform the printed image remains. However, care must likewise be taken that the substrate to be printed does not come into contact with the flexible carrier coated with ink, in order that ink is not transferred from the flexible carrier to the substrate to be printed at undesired points.

The area in which energy is introduced into the ink, part of the ink evaporates and, as a result a drop of ink is transferred to the substrate to be printed is designated the printing area.

In order to achieve a clean printed image, the energy is introduced into the ink through the flexible carrier preferably in a focused manner. The size of the point onto which the energy to be introduced is focused in this case corresponds to the size of the dot to be transferred as a function of the substrate. Dots to be transferred generally have a diameter in the range from about 20 μm to about 200 μm. However, the size of the dot to be transferred can differ, depending on the substrate to be printed and the printed result produced therewith. For instance, it is possible to choose a larger focus, in particular during the production of printed circuit boards. On the other hand, in the case of printed products in which a text is represented, small printing dots are generally preferred in order to produce a clear text image. In addition, when printing images and graphics, it is advantageous to print the smallest possible dots in order to produce a clear image.

The ink carrier used is preferably a flexible carrier. In particular, the ink carrier, which is coated with the ink to be printed, is configured in the form of a belt. The ink carrier is very particularly preferably a thin sheet. In this case, the thickness of the ink carrier preferably lies in the range from 1 μm to approximately 500 μm, in particular in the range from 10 μm to 200 μm. It is advantageous to implement the ink carrier with a low thickness if possible, in order that the energy introduced through the ink carrier is not scattered in the ink carrier, and thus a clean printed image is produced. For example, polymer films that are transparent to the energy used are suitable as a material.

The energy used to evaporate the ink and transfer it to the substrate to be printed is preferably a laser. The advantage of a laser is that the laser beam used can be focused onto a very small cross section. A targeted input of energy is thus possible. In order to evaporate the ink from the ink carrier at least partly and to transfer it to the substrate, it is necessary to convert the light from the laser into heat. To this end, it is firstly possible for a suitable absorber to be contained in the ink, which absorbs the laser light and converts it into heat. Alternatively, it is also possible for the ink carrier to be coated with an appropriate absorber or to be made from such an absorber or to contain such an absorber, which absorbs the laser light and converts it into heat. However, it is preferred for the ink carrier to be made from a material that is transparent to the laser radiation and for the absorber which converts the laser light into heat to be contained in the ink. Suitable absorbers are, for example, carbon blacks, metal nitrites or metal oxides.

Suitable lasers which can be used to introduce energy into the ink are, for example, fiber lasers, which are operated in the basic mode.

Any desired printing ink known to those skilled in the art is suitable as the ink which can be transferred to the substrate to be printed by the method according to the invention. The use of liquid inks is preferred. Liquid inks that are used normally contain at least one solvent and color-forming solids, for example pigments. Alternatively, however, it is also possible for the ink to contain a solvent and electrically conductive particles dispersed in the solvent, for example. In this case, for example, a circuit board can be printed with the ink used. In addition, in particular when a laser is used for the input of energy, it is preferable if the ink also contains an additive which absorbs the laser radiation and converts it into heat.

If conventional printing inks are used, then the substrate to be printed is preferably paper. However, any other desired substrate can also be printed with the method according to the invention. Thus for example paperboard or other paper products, plastics, for example plastic films, metal foils or composite films can also be printed. Plastic films, metal foils or composite films of this type are used, for example, for packaging. The method is also suitable for printing circuit boards. In this case, the substrate to be printed is usually any desired circuit board substrate known to those skilled in the art. The circuit board substrate can be both solid and flexible.

Furthermore, the invention relates to a printing machine, comprising an ink carrier, which is coated with an ink to be printed, and a device for the introduction of energy into the ink, the device for the introduction of energy being arranged in such a way that the energy can be introduced in a printing area on the side of the ink carrier facing away from the ink, so that ink is transferred from the ink carrier to a substrate to be printed in an area of action of the energy. To produce an electric field, in order to produce a homogeneous charge field on the surface of the substrate, a voltage source or a current source is also comprised.

Any desired voltage source or current source known to those skilled in the art is suitable as a voltage source or as a current source for the production of the electric field.

The voltage source or the current source generally comprises a first electrode, with which, in a first embodiment, contact can be made with the substrate. In this case, the contact between the electrode and the substrate is made, for example, by physical contact. In an alternative embodiment, the voltage source or the current source comprises a first electrode, via which, without contact, voltage is applied to the substrate by the application of an electric field, or a current is transferred to the substrate.

In order to produce the homogeneous charge field on the surface of the substrate, it is preferred if the electrode extends over the entire width of the substrate. If the electrode makes contact with the substrate in order to apply the voltage or to transfer the current, then in this case the electrode preferably bears on the substrate over the entire width. If the voltage is applied without contact or the current is transferred without contact, it is preferred if the distance between the substrate and the electrode is constant over the entire length of the electrode, in order to achieve the homogeneous charge distribution on the surface of the substrate.

In order that the first electrode makes contact with the substrate over the entire width, this is preferably constructed in the form of a rod. In this case, the electrode can have a circular or a rectangular cross section, for example. However, any other desired cross section of the electrode is also possible. For instance, the electrode can also be formed with an oval cross section or a polygonal cross section having as many corners as desired. It is also possible to use a plate, for example, as an electrode. In addition, when a plate is used, it is advantageous if the electrode extends over the entire width of the substrate, in order that the charge field produced on the surface of the substrate is homogeneous. Any desired, electrically conductive material known to those skilled in the art is suitable as a material for the electrode. Furthermore, electrodes constructed in the form of combs or brushes are also suitable, the electrodes constructed in the forms of combs or brushes preferably likewise covering the substrate over the entire width.

In order to build up a homogeneous charge field on the surface of the substrate, it is not necessary to provide a defined opposing electrode. However, in one embodiment, it is possible for the voltage source to comprise a second electrode, with which contact can likewise be made with the substrate. In this case, it is for example also possible to apply the first electrode to one side of the substrate and the second electrode to the other side of the substrate, so that a current flows through the substrate. In this way, it is likewise possible to produce a homogeneous charge field on the surface of the substrate.

As already described above, the device for the introduction of energy is preferably a laser.

The ink carrier which can be coated with the ink to be printed is preferably a flexible carrier.

In one embodiment of the printing machine, the ink carrier is stored in a suitable device. To this end, it is possible, for example, for the ink carrier which is coated with ink to be wound up into a roll. For the purpose of printing, the ink carrier coated with ink is then unwound and guided over the printing area, in which, with the aid of the device for the introduction of energy, ink is transferred to the substrate to be printed. The ink carrier is then wound up onto a roller again, for example, which can then be sent to disposal. However, it is preferred for the ink carrier to be formed as a circulating belt. In this case, ink is applied to the ink carrier by a suitable application device before said carrier reaches the printing position, which means the point at which the ink is transferred from the ink carrier to the substrate to be printed with the aid of the input of energy. After the printing operation, some of the ink has been transferred from the ink carrier to the substrate. As a result, there is no longer any homogeneous film of ink on the ink carrier. For a subsequent printing operation, it is therefore necessary to coat the ink carrier with ink again. This is carried out during the next passage past the appropriate position on the ink application device. In order to avoid ink drying on the ink carrier and in order in each case to produce a uniform layer of ink on the ink carrier, it is advantageous to remove the ink on the ink carrier first before a subsequent application of ink to the ink carrier. The removal of the ink can be carried out, for example, with the aid of a roller or a doctor. If a roller is used for the removal of the ink, then it is possible to use the same roller with which the ink is also applied to the ink carrier. To this end, it is advantageous if the rotational movement of the roller is opposed to the movement of the ink carrier. The ink removed from the ink carrier can then be fed to the ink supply again. If a roller is provided to remove the ink, it is of course also alternatively possible for one roller to be provided for the removal of the ink and one roller for the application of ink.

If the ink is to be removed from the ink carrier by a doctor, then any desired doctor known to those skilled in the art can be used.

In order to avoid the ink carrier being damaged during the application of the ink or during the removal of the ink, it is preferable for the ink carrier to be pressed with the aid of a backing roll against the applicator roll with which the ink is applied to the ink carrier or the roller with which the ink is removed from the ink carrier or the doctor with which the ink is removed from the ink carrier. In this case, the back pressure is adjusted in such a way that the ink is removed substantially completely but no damage to the ink carrier occurs.

To improve the printed image further, it is moreover advantageous if the printing machine comprises a tensioning device in order to tension the ink carrier. As a result of the tensioning of the ink carrier, distortion waves which may possibly occur in the ink carrier are smoothed out. In this way, a homogeneous surface can be achieved in the printing area. Different gap widths which, for example, arise as a result of waves in the ink carrier, are thus prevented and the printed image is improved as a result. Furthermore, the printing gap can be adjusted, for example by means of displacing the tensioning device in the direction of the substrate to be printed or away from the latter. A suitable tensioning device comprises, for example, at least two guide elements, which are arranged on the two sides of the device for the introduction of energy. Suitable guide elements are, for example, tensioning rollers, air cushions or non-moving rods. Alternatively, it is also possible for the tensioning device to comprise a guide element that is transparent to the energy used. In this case, the guide element that is transparent to the energy used is located directly at the printing area. This means that the guide element is positioned between the device for the introduction of energy and the flexible carrier, so that the energy with which the ink is transferred from the carrier to the substrate by evaporation has to be led through the guide element.

One embodiment of the invention is illustrated in the FIGURE and will be explained in more detail in the following description.

The single FIGURE shows a schematic illustration of a printing machine constructed in accordance with the invention.

A printing machine 1 comprises an ink carrier 3 which, in the embodiment illustrated here, is designed as an endless belt and is led around a plurality of deflection rollers 5. An ink for printing a substrate 7 is applied to the ink carrier 3.

To print the substrate 7, energy is introduced into the ink through the ink carrier 3 in a printing area 9. As a result of the introduction of the energy into the ink, some of the ink evaporates, by which means a drop of ink is thrown onto the substrate 7. Suitable as the energy which is introduced into the ink is, for example, a laser 11. Suitable lasers 11 which can be used in order to introduce energy into the ink are, for example, fiber lasers, which are operated in the basic mode.

In order to replace the ink transferred to the substrate 7 with the aid of the laser 11, the ink carrier 3 is moved around the deflection rollers 5, as illustrated by the arrow 13. In this case, the transport direction 13 of the ink carrier 3 in the printing area 9 is oriented in the same direction as the transport direction of the substrate 7 to be printed. However, since in general a printing gap 15 is formed between the substrate 7 to be printed and the ink carrier 3, it is also possible for the ink carrier 3 to be moved in the opposite direction to the transport direction of the substrate 7. It is also possible for the ink carrier 3 and substrate 7 to have different speeds. However, the speed of the ink carrier 3 and of the substrate 7 is preferably oriented in the same direction and of equal magnitude. In the embodiment illustrated here, the substrate 7 and the ink carrier 3 are moved in the same direction. The transport direction of the substrate 7 is illustrated by an arrow 17. However, if multiple printing is desired, which means that a line is printed many times, it is advantageous if the ink carrier 3 is moved at a higher speed than the substrate 7.

In order to produce a clean printed image, in particular a printed image having exact edges and borders, a homogeneous charge field is applied to the substrate 7 before the application of the ink. To this end, the printing machine 1 in the embodiment illustrated here comprises a discharging device 19 and a charging device 21. The discharging device 19 used can be any desired current source or voltage source known to those skilled in the art. The charging device 21 used can also be any desired current source or voltage source known to those skilled in the art. Here, the current can be transferred without contact or by means of contact both in the case of the discharging device 19 and in the case of the charging device 21. In addition, the application of a voltage can be carried out without contact or by means of contact. For this purpose, the discharging device 19 or the charging device 21 comprises at least one electrode. The electrode can be constructed, for example, in the form of a rod. Here, the electrode preferably extends over the entire width of the substrate 7 to be printed. A defined opposing electrode is not necessary. Thus, any desired component of the printing machine, for example, can be used as an opposing electrode.

Alternatively, however, it is also possible to provide a first and second electrode. In this case, the transfer of current or the application of the voltage is preferably carried out by means of contact between the electrodes and the substrate 7 to be printed. In this case, the electrodes are preferably applied to the substrate opposite each other in order to produce a homogeneous charge field. The electrodes can be arranged at the sides of the substrate 7 to be printed or, alternatively, on the top side and the underside of the substrate 7 to be printed.

Instead of the use of a discharging device 19 and a charging device 21, it is alternatively also possible to provide either a discharging device 19 or a charging device 21 in order to produce the homogeneous charge field on the surface of the substrate 7. It is also possible, instead of the charging device 21, to provide plasma treatment of the substrate 7, for example, before the ink is applied to the substrate 7.

The ink which is printed onto the substrate 7 in the printing area 9 is applied to the ink carrier 3 by an application device 23. In order to ensure a uniform application of ink, the application device 23 in the embodiment illustrated here comprises an applicator roll 25, with which the ink is applied to the ink carrier 3. The contact pressure required to apply the ink is implemented by means of a backing roll 27, which serves at the same time as a deflection roller 5 for the ink carrier 3. The ink is applied to the applicator roll 25 with the aid of an inking roll 29. In the embodiment illustrated here, the inking roll 29 is inked via an inking plate 31. As an alternative to the inking plate 31, however, the inking roll 29 can also be coated with ink by any other desired device known to those skilled in the art. For instance, it is possible for the inking roll 29 to dip into a storage container having ink and thus be coated with ink. It is also possible to dispense with the inking roll 29 and for only one applicator roll 25 to be provided. It is also possible for more than two rolls to be provided in order to apply the ink to the ink carrier 3.

In order to collect ink dripping off the inking roll 29, a drip catcher 33 is provided in the embodiment illustrated here. Ink collected by the drip catcher 33 is led back into a storage container 35, which contains the ink. The ink contained in the storage container 35 can have solvent added to it from a solvent container 37 as needed. This is necessary, for example, in order to replace solvent that has evaporated from the storage container 35. It is also possible to use the solvent container 37 to supplement solvent which evaporates from the ink which has been applied to the ink carrier 3 and has been removed from the latter again with the aid of the applicator roll 25 after the printing and is led back into the storage container 35. In order to keep the ink in the storage container 35 homogeneous, a stirrer mechanism 39 is also preferably provided. Any desired stirrer mechanism known to those skilled in the art is suitable as the stirrer mechanism 39. For instance, any desired stirrer can be provided. Suitable stirrers are, for example, propeller stirrers, disk stirrers, lattice stirrers, plate stirrers, anchor-shaped stirrers or radial stirrers.

The amount of solvent which has to be metered into the storage container 35 from the solvent container 37 can be determined, for example, by means of viscosity measurement of the ink in the storage container 35. To this end, it is possible, for example, to equip the storage container 35 with a viscometer 41. Via the viscometer 41, the amount of solvent to be metered in is then determined. The viscometer 41 is preferably equipped with an automatic metering system for the solvent.

From the storage container 35, the ink is transported by a circulating pump 43 through a feed line 45 to the inking plate 31. The ink is then applied to the inking roll 29 by the inking plate 31. Excess ink drips back into the drip catcher 33 and from there runs back into the storage container 35 via a return line 47.

In order to avoid ink drying on the ink carrier 3 and thus leading to irregularities and therefore to an impairment of the printed image, ink not transferred to the substrate 7 is removed from the ink carrier 3 again with the aid of the applicator roll 25 after printing. To this end, it is advantageous if the direction of rotation of the applicator roll 25 is opposed to the transport direction 13 of the ink carrier 3. The ink removed from the ink carrier 3 with the aid of the applicator roll 25 is wiped off the applicator roll 25 with the aid of the inking roll 29 and drips into the drip catcher 33, from which it is conveyed back into the storage container 35 via the return line 47.

### LIST OF DESIGNATIONS

1 Printing machine

3 Ink carrier

5 Deflection roller

7 Substrate

9 Printing area

11 Laser

13 Transport direction of the ink carrier 3

15 Print gap

17 Transport direction of the substrate 7

19 Discharging device

21 Charging device

23 Application device

25 Applicator roll

27 Backing roll

29 Inking roll

31 Inking plate

33 Drip catcher

35 Storage container

37 Solvent container

39 Stirrer mechanism

41 Viscometer

43 Circulating pump

45 Feed line

47 Return line

1. A method for printing a substrate, the method comprising:
transferring ink from an ink carrier to the substrate in accordance with a predefined pattern by energy being introduced into the ink through the ink carrier by a device for introducing energy,
wherein the ink carrier and the substrate do not come into contact,
and wherein the substrate is introduced into an electric field, so that a charge field is produced on a surface of the substrate.

2. The method of claim 1, wherein the charge field is homogeneous.

3. The method of claim 1, wherein the electric field is produced by applying a voltage or transferring a current.

4. The method of claim 1, wherein the substrate is introduced into the electric field before the ink is transferred.

5. The method of claim 1, wherein the substrate is substantially discharged homogeneously as a result of introducing the substrate into the electric field.

6. The method of claim 1, wherein the substrate is substantially charged up homogeneously as a result of introducing the substrate into the electric field.

7. The method of claim 1, wherein the substrate is initially discharged and then charged up.

8. The method of claim 1, wherein the ink carrier has a spacing from the substrate in a range from 0.01 to 2 mm.

9. The method of claim 1, wherein the device for introducing energy is a laser.

10. A printing machine, comprising
an ink carrier, which can be coated with an ink to be printed;
a voltage source or a current source; and
a device for introducing energy into the ink,
wherein the device for introducing energy is arranged in such a way that the energy can be introduced in a printing area on a side of the ink carrier that faces away from the ink, so that ink is transferred from the ink carrier to a substrate to be printed in an area of action of the energy,
and wherein the voltage source or current source are suitable to produce a homogeneous charge field on a surface of the substrate.

11. The printing machine of claim 10, wherein the voltage source or the current source comprises a first electrode, with which contact can be made with the substrate.

12. The printing machine of claim 11, wherein the first electrode is constructed in the form of a rod, which is arranged in such a way that the rod makes contact with the substrate over its entire width.

13. The printing machine of claim 10, wherein the voltage source comprises a second electrode, with which contact can likewise be made with the substrate.

14. The printing machine of claim 10, wherein the device for introducing energy is a laser.

15. The method of claim 2, wherein the electric field is produced by applying a voltage or transferring a current.

16. The method of claim 2, wherein the substrate is introduced into the electric field before the ink is transferred.

17. The method of claim 3, wherein the substrate is introduced into the electric field before the ink is transferred.

18. The method of claim 2, wherein the substrate is substantially discharged homogeneously as a result of introducing the substrate into the electric field.

19. The method of claim 3, wherein the substrate is substantially discharged homogeneously as a result of introducing the substrate into the electric field.

20. The method of claim 4, wherein the substrate is substantially discharged homogeneously as a result of introducing the substrate into the electric field.
